(19) United States
(12) Patent Application Publication
(10) Pub. No.: US 2026/0112929 A1
(43) Pub. Date: Apr. 23, 2026

(54) DIRECT MAGNET COOLING WITH FLOW RATE RESTRICTION HOLES IN LAMINATION DESIGN FOR SPIN-LOSS REDUCTION

(71) Applicant: GM GLOBAL TECHNOLOGY OPERATIONS LLC, DETROIT, MI (US)

(72) Inventors: Rebecca K Risko Cattell, Royal Oak, MI (US); Matthew James Bozich, Warren, MI (US); Edward L. Kaiser, Orion, MI (US); Cheongun Han, Novi, MI (US)

(21) Appl. No.: 18/919,884

(22) Filed: Oct. 18, 2024

(51) Int. Cl. H02K 1/32; H02K 1/276

(52) U.S. Cl. CPC H02K 1/32; H02K 1/276

(57) ABSTRACT

A rotor for an electric machine includes a rotor body formed from stacked laminations with aligned magnet slots and central apertures defining a shaft slot. A shaft within the slot has radial apertures connected to an axial channel. A first subset of laminations defines a first fluid passage with portions extending radially and axially to direct fluid to magnet slots. The fourth portion of the passage has a triangular cross-section to evenly split fluid flow. A second subset of laminations defines a second fluid passage with similar features. The rotor includes eight radial apertures evenly spaced around the shaft circumference, with laminations having openings aligned to these apertures to regulate fluid flow, enhancing cooling and reducing spin-loss.

### BACKGROUND

The subject disclosure relates to vehicles, and in particular to internal permanent magnet motors with enhanced cooling mechanisms and reduced spin-loss features.

Electric motors, particularly internal permanent magnet (IPM) motors, are widely used in various applications due to their high efficiency and power density. These motors utilize permanent magnets embedded within the rotor to generate a magnetic field, which interacts with the stator windings to produce torque. However, IPM motors often face challenges related to efficient cooling and reducing rotational energy losses, commonly referred to as spin-loss.

Traditional designs typically direct oil through the rotor to cool the internal components, including the magnets. However, this approach may not adequately cool the magnets or optimize rotational energy efficiency. The oil may not effectively reach the magnets, leading to suboptimal cooling and potential overheating. Additionally, the distribution of oil within the rotor can impact the motor's rotational energy efficiency, as oil may not be optimally directed to reduce friction and other resistive forces.

Existing solutions may not provide a mechanism to control the distribution of oil between the rotor and the magnets, resulting in inefficiencies in cooling and increased rotational energy losses. Uneven cooling can occur, where some areas receive excessive oil while others remain inadequately cooled. Furthermore, the inability to regulate oil flow can lead to increased spin-loss, compromising the motor's overall performance and reliability.

Accordingly, there is a need for a design that allows for precise control of oil flow to the magnets and the rotor, thereby enhancing cooling efficiency and reducing rotational energy losses. Such a design would enable better thermal management of the magnets and improve overall motor performance, ensuring optimal operation and longevity of the motor.

### SUMMARY

According to one aspect of the present invention, a rotor for an electric machine includes a rotor body formed from a plurality of stacked laminations defining a first axial end and an opposing second axial end, each of the plurality of stacked laminations having a plurality of magnet slots that are aligned through the rotor body and central apertures that are aligned so as to define a shaft slot. The rotor also includes a shaft disposed within the shaft slot and the shaft has a plurality of radial apertures fluidly connected to an axial channel disposed within the shaft. A first subset of the plurality of stacked laminations includes openings that define a first fluid passage that includes a first portion that extends from a first aperture of the plurality of radial apertures in a radial direction away from the shaft. The first fluid passage also includes a second portion that extends from the first portion in an axial direction towards the first axial end, a third portion that extends from the second portion in the radial direction away from the shaft, a fourth portion that extends from the third portion in the axial direction towards the second axial end, a fifth portion that extends from the fourth portion to a first magnet slot of the plurality of magnet slots, and a sixth portion that extends from the fourth portion to a second magnet slot of the plurality of magnet slots.

According to another aspect, the rotor includes the fourth portion of the first fluid passage having a cross-sectional shape that is triangular and has a first, second, and third sides, wherein the first side is generally parallel with the second portion of the first fluid passage, the fifth portion extends from the second side, and the sixth portion extends from the third side.

According to yet another aspect, the rotor includes the shape of the fourth portion of the first fluid passage having a cross-sectional shape that is configured to evenly split a fluid flowing through the fourth portion to the fifth portion and the sixth portion during the operation of the electric machine.

According to another aspect, the rotor includes the first subset of the plurality of stacked laminations having a first lamination that includes an opening that is configured to align with the first aperture, wherein dimensions of the opening are configured to regulate a flow of a fluid through the first fluid passage.

According to yet another aspect, the rotor includes a second subset of the plurality of stacked laminations having openings that define a second fluid passage that includes a first portion that extends from a second aperture of the plurality of radial apertures in the radial direction away from the shaft, a second portion that extends from the first portion in an axial direction towards the second axial end, a third portion that extends from the second portion in the radial direction away from the shaft, a fourth portion that extends from the third portion in the axial direction towards the first axial end, a fifth portion that extends from the fourth portion to a third magnet slot of the plurality of magnet slots, and a sixth portion that extends from the fourth portion to a fourth magnet slot of the plurality of magnet slots.

According to another aspect, the rotor includes the second subset of the plurality of stacked laminations being disposed adjacent to the first subset of the plurality of stacked laminations.

According to yet another aspect, the rotor includes the plurality of radial apertures having eight apertures evenly spaced around a circumference of the shaft.

According to another aspect, the rotor includes the plurality of stacked laminations having a first lamination with four openings that are configured to align with a first four of the eight apertures.

According to yet another aspect, the rotor includes the plurality of stacked laminations having a second lamination with four openings that are each configured to align with a second four of the eight apertures.

According to another aspect, the rotor includes at least two of the first four apertures being immediately adjacent to one another.

According to yet another aspect, an electric machine includes a stator; and a rotor rotatably arranged within the stator, the rotor having a plurality of stacked laminations defining a first axial end and an opposing second axial end, each of the plurality of stacked laminations having a plurality of magnet slots that are aligned through a rotor body and central apertures that are aligned so as to define a shaft slot. The rotor also includes a shaft disposed within the shaft slot and the shaft has a plurality of radial apertures fluidly connected to an axial channel disposed within the shaft. A first subset of the plurality of stacked laminations includes openings that define a first fluid passage that includes a first portion that extends from a first aperture of the plurality of radial apertures in a radial direction away from the shaft. The first fluid passage also includes a second portion that extends from the first portion in an axial direction towards the first axial end, a third portion that extends from the second portion in the radial direction away from the shaft, a fourth portion that extends from the third portion in the axial direction towards the second axial end, a fifth portion that extends from the fourth portion to a first magnet slot of the plurality of magnet slots, and a sixth portion that extends from the fourth portion to a second magnet slot of the plurality of magnet slots.

According to another aspect, the electric machine includes the fourth portion of the first fluid passage having a cross-sectional shape that is triangular and has a first, second and third sides, wherein the first side is generally parallel with the second portion of the first fluid passage, the fifth portion extends from the second side, and the sixth portion extends from the third side.

According to yet another aspect, the electric machine includes the shape of the fourth portion of the first fluid passage having a cross-sectional shape that is configured to evenly split a fluid flowing through the fourth portion to the fifth portion and the sixth portion during operation of the electric machine.

According to another aspect, the electric machine includes the first subset of the plurality of stacked laminations having a first lamination that includes an opening that is configured to align with the first aperture, wherein dimensions of the opening are configured to regulate a flow of a fluid through the first fluid passage.

According to yet another aspect, the electric machine includes a second subset of the plurality of stacked laminations having openings that define a second fluid passage that includes a first portion that extends from a second aperture of the plurality of radial apertures in the radial direction away from the shaft, a second portion that extends from the first portion in an axial direction towards the second axial end, a third portion that extends from the second portion in the radial direction away from the shaft, a fourth portion that extends from the third portion in the axial direction towards the first axial end, a fifth portion that extends from the fourth portion to a third magnet slot of the plurality of magnet slots, and a sixth portion that extends from the fourth portion to a fourth magnet slot of the plurality of magnet slots.

According to another aspect, the electric machine includes the second subset of the plurality of stacked laminations being disposed adjacent to the first subset of the plurality of stacked laminations.

According to yet another aspect, the electric machine includes the plurality of radial apertures having eight apertures evenly spaced around a circumference of the shaft.

According to another aspect, the electric machine includes the plurality of stacked laminations having a first lamination with four openings that are configured to align with a first four of the eight apertures.

According to yet another aspect, the electric machine includes the plurality of stacked laminations having a second lamination with four openings that are each configured to align with a second four of the eight apertures.

According to another aspect, the electric machine includes at least two of the first four apertures being immediately adjacent to one another.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2A illustrates a lamination design of a first lamination of a rotor body in conjunction with one or more embodiments of the present disclosure;

FIG. 2B illustrates a lamination design of a second lamination of a rotor body in conjunction with one or more embodiments of the present disclosure;

FIG. 2C illustrates a lamination design of a core lamination of a rotor body in conjunction with one or more embodiments of the present disclosure;

FIG. 2D illustrates a side view of a rotor stack illustrating an arrangement of laminations in conjunction with one or more embodiments of the present disclosure;

FIG. 3 illustrates a composite view of a stack of laminations including a first lamination, a second lamination, and one or more core laminations in conjunction with one or more embodiments of the present disclosure;

FIG. 4 illustrates a schematic diagram of a rotor shaft with radial apertures for oil distribution.

FIG. 5 illustrates a cross-sectional view of the rotor assembly showing the oil flow paths through the rotor and magnet slots in conjunction with one or more embodiments of the present disclosure;

FIG. 6A illustrates a cross-sectional view of the rotor assembly showing the oil flow through a first fluid passage through the rotor body and shaft in conjunction with one or more embodiments of the present disclosure;

FIG. 6B illustrates a cross-sectional view of the rotor assembly showing the oil flow through a second fluid passage through the rotor body and shaft in conjunction with one or more embodiments of the present disclosure; and

FIGS. 7A, 7B, 7C, and 7D illustrate lamination designs of a rotor body in conjunction with one or more embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electric motors, particularly internal permanent magnet (IPM) motors, often encounter significant challenges in achieving efficient cooling and minimizing spin-loss. The cooling of internal components, such as magnets, is important for maintaining optimal performance and longevity of the motor. Traditional cooling methods typically involve directing oil through the rotor, which may not effectively reach the magnets, leading to suboptimal cooling and potential overheating. Additionally, the distribution of oil within the rotor can impact the motor's rotational energy efficiency, commonly referred to as spin-loss.

Existing solutions in the field of internal permanent magnet motors generally lack mechanisms to precisely control the distribution of oil between the rotor and the magnets. This can result in uneven cooling, where some areas receive excessive oil while others remain inadequately cooled. Furthermore, the inability to regulate oil flow can lead to increased rotational energy losses, as oil may not be optimally directed to reduce friction and other resistive forces. These inefficiencies can compromise the motor's overall performance and reliability.

The present design addresses these challenges by introducing a novel internal permanent magnet rotor assembly that incorporates specific features in the rotor laminations, end rings, and shaft. This design enables oil entering the rotor shaft to be split between a path directly to the magnets and a path through the remainder of the rotor. The oil is fed to the rotor via the shaft inner diameter and radially drilled holes in the shaft, which direct the oil to the rotor. The lamination features create a flow path that allows a portion of the oil to enter the magnet slots, while the remainder flows between the inner diameter channels and the shaft outer diameter.

The lamination stamping design and the stack-up of the laminations in specific rotation orientations create the oil flow path to the magnet slots. The size of the orifice that allows oil to enter the magnet slots can be modified to control the amount of oil directed to the magnets. The remaining oil travels axially between the inner diameter and the shaft outer diameter, exiting through openings in the end rings that sandwich the inner diameter. This design provides a mechanism to precisely control the distribution of oil, enhancing cooling efficiency and reducing spin-loss.

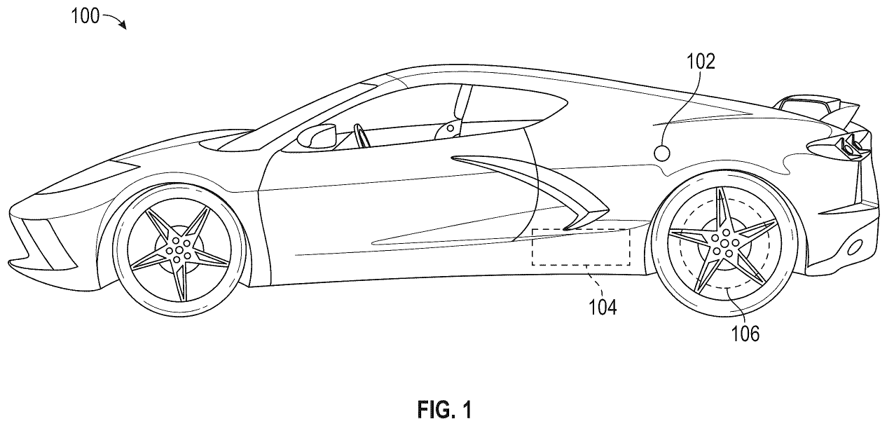

Referring now to FIG. 1, a schematic diagram of a vehicle 100 for use in conjunction with one or more embodiments of the present disclosure is shown. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a high-voltage power source (i.e., a voltage source of at least 200 volts (V)), which is used to charge the battery 104. The electric motor 106 is configured to receive power from the battery 104 to provide propulsion for the vehicle 100. In exemplary embodiments, the battery 104 is configured to supply direct-current (DC) power to an inverter (not shown), which converts the DC power into three-phase alternating-current (AC) power. The three-phase AC power is supplied to the electric motor 106 to provide propulsion for the vehicle 100.

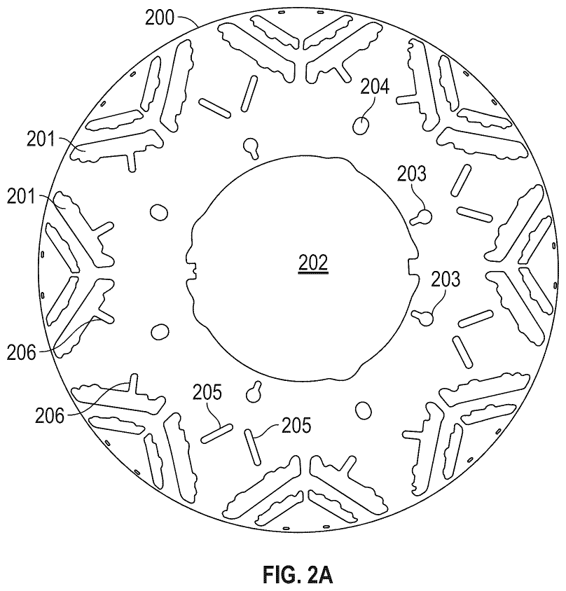

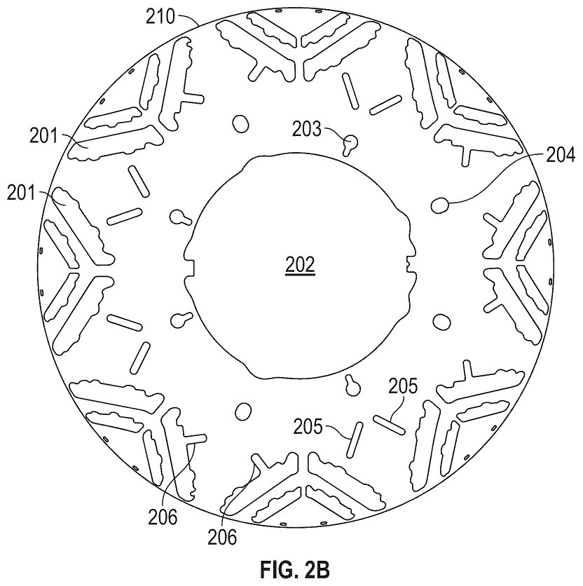

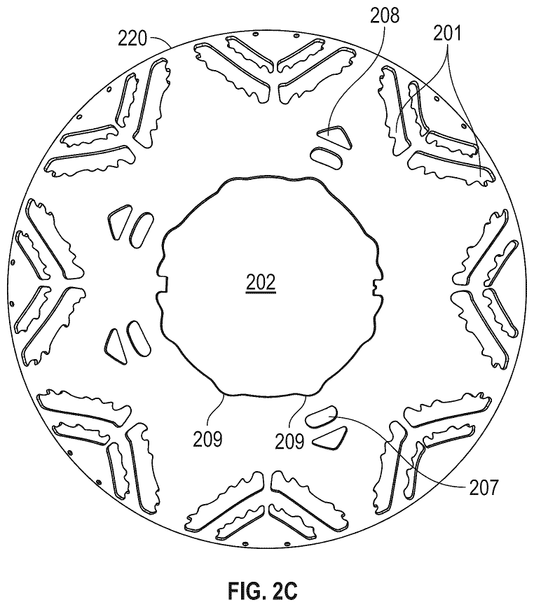

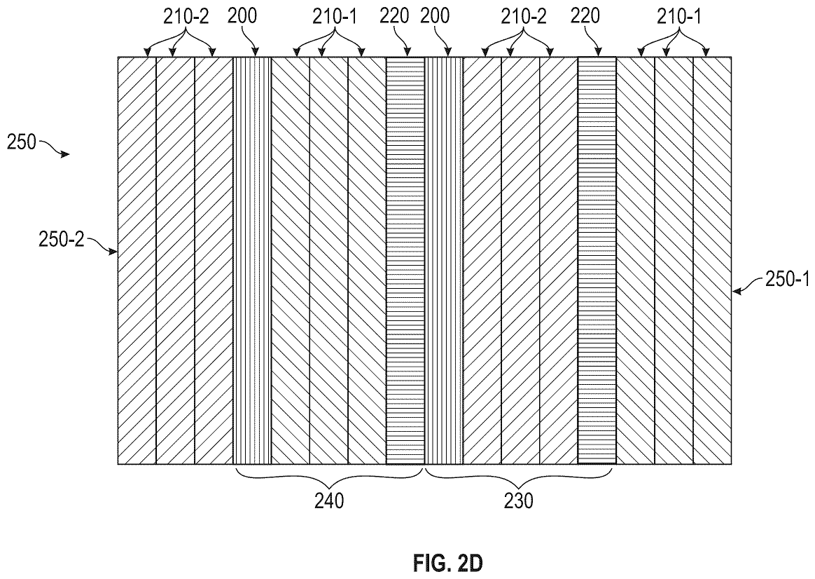

Referring now to FIG. 2A, a lamination design of a first lamination 200 of a rotor body in accordance with an embodiment is shown. The first lamination 200 includes magnet slots 201, a central aperture 202, first openings 203, second openings 204, third openings 205, and fourth openings 206. The first lamination 200 forms part of the rotor body and is designed to facilitate the cooling and reduction of spin-loss in the rotor. The first lamination 200 is one of the multiple laminations that are stacked to form the rotor body. In exemplary embodiments, the magnet slots 201 are distributed circumferentially around the first lamination 200 and are designed to house the magnets. These slots ensure that the magnets are securely positioned within the rotor body, allowing for efficient magnetic interaction with the stator windings. In exemplary embodiments, the central aperture 202 is located at the center of the first lamination 200. This aperture is aligned with the central apertures of other laminations to define a shaft slot, which accommodates the rotor shaft.

In exemplary embodiments, the first opening 203 is positioned radially near the central aperture 202 and is designed to align with a radial aperture in the rotor shaft. This opening facilitates the flow of oil from the shaft to the magnet slots 201. The second opening 204 is radially between the central aperture 202 and the magnet slots 201. The openings of core laminations rotor body combine to define a fluid passage for the distribution of oil. The fluid passage extends between the first opening 203 to the magnet slots 201. The third openings 205 and fourth openings 206 are distributed circumferentially around the first lamination 200 and are designed to further facilitate the flow of oil within the rotor body. These openings help in directing the oil toward the magnet slots 201.

FIG. 2B illustrates a lamination design of a second lamination 210 of a rotor body in accordance with an embodiment. The first lamination 200 includes magnet slots 201, a central aperture 202, a first opening 203, a second opening 204, third openings 205, and fourth openings 206. In exemplary embodiments, the second lamination 210 has a substantially similar configuration to the first lamination 200 rotated about the central aperture by forty-five degrees.

Referring now to FIG. 2C, a lamination design of a core lamination 220 of a rotor body in accordance with an embodiment is shown. The core lamination 220 includes magnet slots 201, a central aperture 202, a first axial channel opening 207, a second axial channel opening 208, and an indentation 209. Magnet slots 201 are distributed around the lamination and are designed to house the magnets. These slots ensure that the magnets are securely positioned within the rotor body, allowing for efficient magnetic interaction with the stator windings. Central aperture 202 is located at the center of the lamination. This aperture is aligned with the central apertures of other laminations to define a shaft passage, which accommodates the rotor shaft.

In exemplary embodiments, the first axial channel opening 207 is part of the axial channel system within the rotor. The first axial channel opening 207 allows oil to flow axially through a portion of the rotor body. The second axial channel opening 208 is another component of the axial channel system. In exemplary embodiments, the second axial channel opening 208 has a triangular cross-sectional shape with a first surface that is generally parallel to the first axial channel opening 207. In exemplary embodiments, the indentations 209 are configured to partially overlap the first opening 203 of one of the first lamination 200 and the second lamination 210 when the core lamination 220 is disposed adjacent to one of the first lamination 200 and the second lamination 210. In exemplary embodiments, the dimensions of the overlap between the first opening 203 and the indentation 209 is configured to control the percentage of oil that flows radially into the rotor body and the percentage of oil that flows axially between the rotor body and the rotor shaft.

Referring now to FIG. 2D, a side view of a rotor stack illustrating an arrangement of laminations in conjunction with one or more embodiments of the present disclosure is shown. The rotor body 250 includes a plurality of stacked laminations that are stacked between a first axial end 250-1 and a second axial end 250-2. The rotor body 250 is formed from a plurality of stacked laminations, including first lamination 200, core laminations 210-1, rotated core laminations 210-2, and core lamination 220.

In exemplary embodiments, rotor body 250 includes a first subset of stacked laminations 230 that includes one or more rotated core laminations 210-2 disposed between a first lamination 200 and a second lamination 210. The first subset of stacked laminations 230 includes openings, such as those shown in FIGS. 2A-2C, that define a first fluid passage, which facilitates oil flow through a first portion of rotor body to cool the magnets and reduce spin-loss in the rotor.

In exemplary embodiments, rotor body 250 also includes a second subset of stacked laminations 240 that includes one or more core laminations 210-1 disposed between a first lamination 200 and a second lamination 210. The first subset of stacked laminations 230 includes openings, such as those shown in FIGS. 2A-2C, that define a second fluid passage, which facilitates oil flow through a second portion of rotor body to cool the magnets and reduce spin-loss in the rotor. In exemplary embodiments, the rotated core laminations 210-2 have the same layout as the core laminations 210-1, but the rotated core laminations 210-2 have been rotated about the shaft of the rotor body by forty-five degrees.

In exemplary embodiments, the first subset of stacked laminations 230 is disposed adjacent to the second subset of stacked laminations 240. The first fluid passage is configured to provide oil flow to a different set of magnets than the second fluid passage. Although the first subset of stacked laminations 230 and the second subset of stacked laminations 240 are illustrated as having three stacked core laminations 210-1 and rotated core laminations 210-2, it will be appreciated by those of ordinary skill in the art that any number of core laminations may be used.

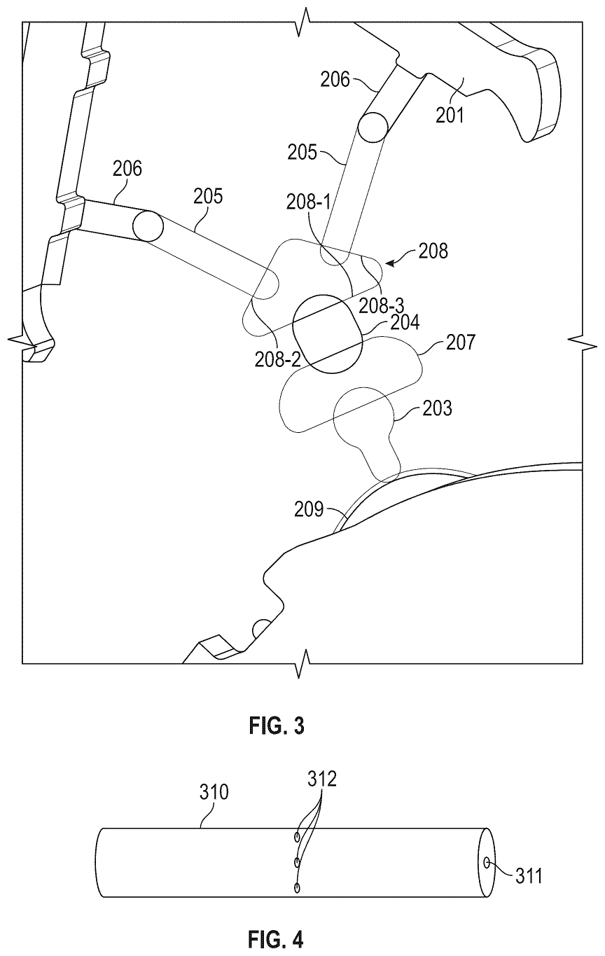

Referring now to FIG. 3, a composite view of a stack of laminations, including a first lamination, a second lamination, and one or more core laminations in accordance with an embodiment is shown. The first opening 203 is positioned near the central aperture and aligns with a radial aperture in the rotor shaft. As illustrated, indentation 209 of the core laminations, overlaps with a first end of the first opening 203 of the first lamination. An opposing end of the first opening 203 overlaps with the first axial channel opening 207 of the core laminations. The second opening 204 on the second lamination overlaps both the first axial channel opening 207 and the second axial channel opening 208. In exemplary embodiments, the second axial channel opening 208 has a triangular shape and includes a first side 208-1 that is generally parallel to the first axial channel opening 207 and a second and third sides 208-2 and 208-3 that extend from the first side 208-1 away from the first axial channel opening 207. In exemplary embodiments, the second side 208-2 of the second axial channel opening 208 overlaps one of the third openings 205 and the third side 208-3 of the second axial channel opening 208 overlaps the other of the third openings 205 of the first lamination. Further, each of the third openings 205 of the first lamination overlap fourth openings 206 of the second lamination. The fourth openings 206 of the second lamination are configured to connect to the magnet slots 201. In exemplary embodiments, the first openings 203, second openings 204, third openings 205, fourth openings 206, first axial channel opening 207, and second axial channel opening 208 in the stack of laminations combine to define a fluid passage that extends from radial aperture in the rotor shaft to the magnet slots 201 to facilitate oil flow through the rotor body to the magnets.

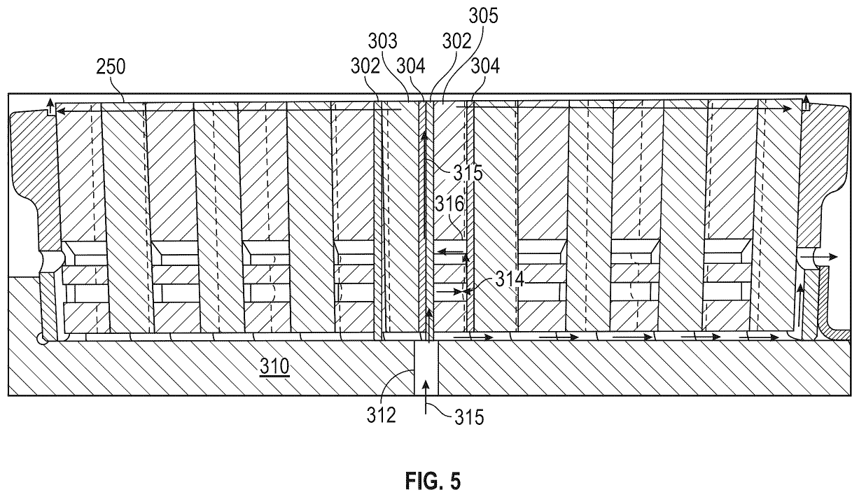

FIG. 4 shows a schematic diagram of a shaft 310 with radial apertures 312 for oil distribution in accordance with an embodiment. In exemplary embodiments, the shaft 310 is a cylindrical component that forms the central axis of the rotor assembly. The shaft 310 is configured to be inserted into the central apertures of the rotor laminations. The shaft 310 includes a central aperture 311 that extends axially through at least a portion of the shaft 310 and connects to the radial apertures 312. In exemplary embodiments, a plurality of radial apertures 312 are distributed along the circumference of the shaft 310. These apertures are designed to facilitate the flow of oil from the shaft 310 to the rotor laminations and magnet slots. The radial apertures 312 connect the internal axial channel of the shaft 310 to the external surface, allowing oil to be directed radially outward to cool the internal components of the rotor assembly. In one embodiment, the shaft 310 includes eight radial apertures 312 that are evenly distributed around the circumference of the shaft 310. In one embodiment, the plurality of radial apertures 312 are located in a central portion of the shaft 310.

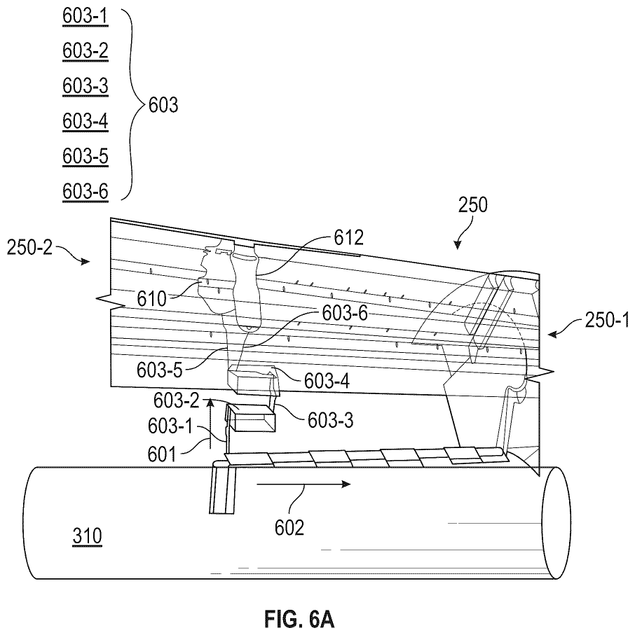

FIG. 5 shows a cross-sectional view of a rotor assembly illustrating the oil flow paths through the rotor body 250. The rotor assembly includes a rotor body 250, a first lamination 302, core laminations 303, a second lamination 304, rotated core laminations 305, a shaft 310, radial apertures 312, a first axial channel 314, a radial channel 315, and a second axial channel 316.

The rotor body 250 forms the central structure of the rotor assembly and is composed of multiple stacked laminations, including the first lamination 302, core laminations 303, the second lamination 304, and rotated core laminations 305. These laminations are arranged to facilitate the flow of oil and enhance the cooling efficiency of the rotor assembly. The first lamination 302 is positioned near the central portion of the rotor body 250. The first lamination 302 includes openings that align with the radial apertures 312 in the shaft 310, allowing oil to flow from the shaft 310 into the rotor body 250. The first lamination 302 also helps direct the oil towards the magnet slots within the rotor body 250.

In exemplary embodiments, the core laminations 303 are disposed between the first lamination 302 and the second lamination 304. The core laminations 303 have openings that define channels that facilitate the axial flow of oil through a portion of the rotor body 250. These channels include a first axial channel (not shown) and the second axial channel (not shown), which guide the oil flow through different sections of the rotor body 250. In exemplary embodiments, a first fluid flow passage is defined through the first lamination 302, the core laminations 303, and the second lamination 304. The first fluid flow passage facilitates the flow of fluid from a radial aperture 312 of the shaft to a first and second magnet slots. In exemplary embodiments, the axial flow of the oil in the second axial channel 316 ensures an even distribution of the oil to the two magnet slots that are fluidly connected to the radial channel 315. In exemplary embodiments, as the rotor body 250 spins a centrifugal force acts on the oil disposed in the second axial channel 316, and the geometry of the second axial channel 316 is configured to evenly distribute the oil to the two the magnet slots that are fluidly connected to the radial channel 315.

In exemplary embodiments, the rotated core laminations 305 are stacked between the first lamination 302 and the second lamination 304. The rotated core laminations 305 have openings that define channels that facilitate the axial flow of oil through a portion of the rotor body 250. These channels include a first axial channel 314 and the second axial channel 316, which guide the oil flow through different sections of the rotor body 250. In exemplary embodiments, a second fluid flow passage is defined through the first lamination 302, the rotated core laminations 305, and the second lamination 304. The second fluid flow passage facilitates the flow of fluid from a radial aperture 312 of the shaft to a third and fourth magnet slots. In exemplary embodiments, the axial flow of the oil in the second axial channel 316 ensures an even distribution of the oil to the two magnet slots that are fluidly connected to the radial channel 315. In exemplary embodiments, as the rotor body 250 spins a centrifugal force acts on the oil disposed in the second axial channel 316 and the geometry of the second axial channel 316 is configured to evenly distribute of the oil to the two the magnet slots that are fluidly connected to the radial channel 315.

In exemplary embodiments, the shaft 310 is positioned within the central aperture of the rotor body 250. The shaft 310 includes radial apertures 312, see FIG. 4, that allow oil to flow from the internal axial channel of the shaft 310 into the rotor body 250. The radial apertures 312 connect the internal axial channel of the shaft 310 to the external surface, facilitating the radial flow of oil into the rotor body 250.

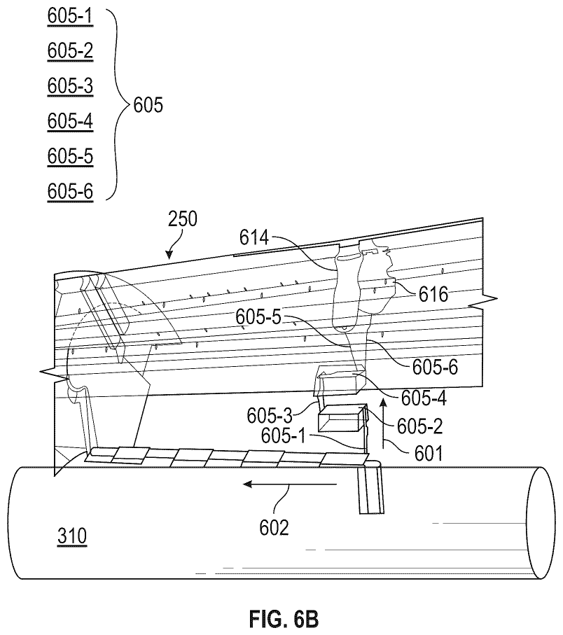

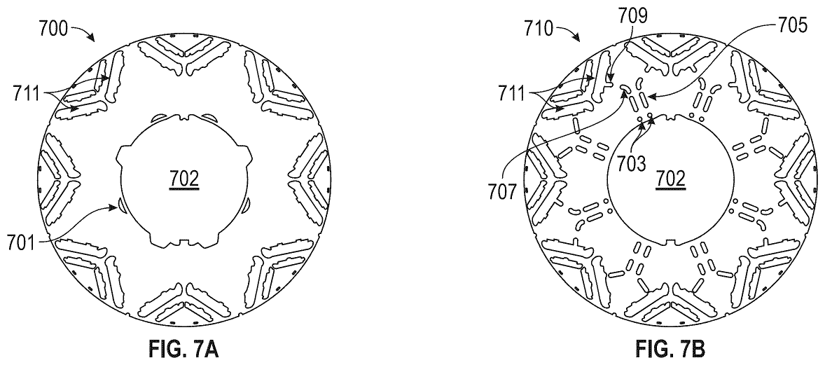

Referring now to FIG. 6A, a cross-sectional view of the rotor assembly showing the oil flow through a first fluid passage through the rotor body and shaft in conjunction with one or more embodiments of the present disclosure is shown. The rotor assembly includes a rotor body 250 that is composed of multiple stacked laminations that are designed to facilitate the flow of oil and enhance the cooling efficiency of the rotor assembly. The rotor body 250 includes a first fluid passage 603 that extends through the rotor body 250 and the shaft 310. The first fluid passage 603 is configured to direct oil flow through the rotor body 250 to cool the magnets and reduce spin-loss in the rotor.

The shaft 310 is positioned within the central aperture of the rotor body 250. The shaft 310 includes a plurality of radial apertures 312 that are fluidly connected to an axial channel disposed within the shaft 310. The radial apertures 312 facilitate the flow of oil from the internal axial channel of the shaft 310 into the rotor body 250. The radial apertures 312 connect the internal axial channel of the shaft 310 to the external surface, allowing oil to be directed radially outward to cool the internal components of the rotor assembly.

The first fluid passage 603 includes a first portion 603-1 that extends from a first aperture of the plurality of radial apertures 312 in a radial direction 601 away from the shaft 310. The first portion 603-1 of the first fluid passage 603 directs oil radially outward from the shaft 310. The first fluid passage 603 further includes a second portion 603-2 of the first fluid passage 603 that extends from the first portion 603-1 in an axial direction 602 towards a first axial end 250-1 of the rotor body 250. The second portion 603-2 of the first fluid passage 603 facilitates the axial flow of oil through a portion of the rotor body 250.

The first fluid passage 603 also includes a third portion 603-3 that extends from the second portion 603-2 in the radial direction 601 away from the shaft 310. The third portion 603-3 of the first fluid passage directs oil radially outward from the axial channel towards the magnet slots. The first fluid passage 603 further includes a fourth portion 603-4 of the first fluid passage that extends from the third portion 603-3 of the first fluid passage 603 in the axial direction 602 towards the second axial end 250-2 of the rotor body 250. The fourth portion 603-4 of the first fluid passage facilitates the axial flow of oil a portion of the rotor body 250.

The first fluid passage 603 includes a fifth portion 603-5 that extends from the fourth portion 603-4 to a first magnet slot 610 of the plurality of magnet slots. The fifth portion 603-5 directs oil to the first magnet slot 610 to cool the magnet housed within the slot. The first fluid passage 603 also includes a sixth portion 603-6 that extends from the fourth portion 603-4 to a second magnet slot 612 of the plurality of magnet slots. The sixth portion 603-6 directs oil to the second magnet slot 612 to cool the magnet housed within the slot.

In exemplary embodiments, the fourth portion 603-4 of the first fluid passage 603 has a cross-sectional shape that is triangular and has a first side, a second side, and a third side. The first side is generally parallel with the second portion 603-2 of the first fluid passage 603. The fifth portion 603-5 of the first fluid passage 603 extends from the second side, and the sixth portion 603-6 of the first fluid passage 603 extends from the third side. The cross-sectional shape of the fourth portion 603-4 of the first fluid passage 603 is configured to evenly split a fluid flowing through the fourth portion 603-4 of the first fluid passage 603 between the fifth portion 603-5 and the sixth portion 603-6 of the first fluid passage 603 during operation of the electric machine.

In exemplary embodiments, the first subset of the plurality of stacked laminations includes a first lamination that includes an opening that is configured to align with the first aperture of the plurality of radial apertures 312. The dimensions of the opening are configured to regulate the flow of a fluid through the first fluid passage 603. The first subset of the plurality of stacked laminations ensures that the oil flow is directed efficiently through the rotor body 250 to the magnet slots, enhancing the cooling efficiency and reducing spin-loss in the rotor.

Referring now to FIG. 6B, a cross-sectional view of the rotor assembly showing the oil flow through a second fluid passage through the rotor body and shaft in conjunction with one or more embodiments of the present disclosure is shown. The rotor assembly includes a rotor body 250 that is composed of multiple stacked laminations that are designed to facilitate the flow of oil and enhance the cooling efficiency of the rotor assembly. The rotor body 250 includes a second fluid passage 605 that extends through the rotor body 250 and the shaft 310. The second fluid passage 605 is configured to direct oil flow through the rotor body 250 to cool the magnets and reduce spin-loss in the rotor.

The shaft 310 is positioned within the central aperture of the rotor body 250. The shaft 310 includes a plurality of radial apertures, shown in FIG. 4, that are fluidly connected to an axial channel disposed within the shaft 310. The radial apertures facilitate the flow of oil from the internal axial channel of the shaft 310 into the rotor body 250. The radial apertures connect the internal axial channel of the shaft 310 to the external surface, allowing oil to be directed radially outward to cool the internal components of the rotor assembly.

The second fluid passage 605 includes a first portion 605-1 that extends from a second aperture of the plurality of radial apertures in a radial direction 601 away from the shaft 310. The first portion 605-1 of the second fluid passage 605 directs oil radially outward from the shaft 310. The second fluid passage 605 further includes a second portion 605-2 of the second fluid passage 605 that extends from the first portion 605-1 in an axial direction 602 towards a second axial end 250-2 of the rotor body 250. The second portion 605-2 of the second fluid passage 605 facilitates the axial flow of oil through a portion of the rotor body 250.

The second fluid passage 605 also includes a third portion 605-3 of the second fluid passage that extends from the second portion 605-2 in the radial direction 601 away from the shaft 310. The third portion 605-3 of the second fluid passage directs oil radially outward from the axial channel towards the magnet slots. The second fluid passage 605 further includes a fourth portion 605-4 of the second fluid passage that extends from the third portion 605-3 of the second fluid passage in the axial direction 602 towards the first axial end 250-1 of the rotor body 250. The fourth portion 605-4 of the second fluid passage facilitates the axial flow of oil through another section of the rotor body 250.

The second fluid passage 605 includes a fifth portion 605-5 that extends from the fourth portion 605-4 to a third magnet slot 614 of the plurality of magnet slots. The fifth portion 605-5 directs oil to the third magnet slot 614 to cool the magnet housed within the slot. The second fluid passage 605 also includes a sixth portion 605-6 that extends from the fourth portion 605-4 to a fourth magnet slot 616 of the plurality of magnet slots. The sixth portion 605-6 directs oil to the fourth magnet slot 616 to cool the magnet housed within the slot.

In exemplary embodiments, the fourth portion 605-4 of the second fluid passage 605 has a cross-sectional shape that is triangular and has a first side, a second side, and a third side. The first side is generally parallel with the second portion 605-2 of the second fluid passage 605. The fifth portion 605-5 of the second fluid passage 605 extends from the second side, and the sixth portion 605-6 of the second fluid passage 605 extends from the third side. The cross-sectional shape of the fourth portion 605-4 of the second fluid passage 605 is configured to evenly split a fluid flowing through the fourth portion 605-4 of the second fluid passage 605 to the fifth portion 605-5 of the second fluid passage 605 and the sixth portion 605-6 of the second fluid passage 605 during operation of the electric machine.

In exemplary embodiments, the second subset of the plurality of stacked laminations includes a second lamination that includes an opening that is configured to align with the first aperture of the plurality of radial apertures. The dimensions of the opening are configured to regulate the flow of a fluid through the second fluid passage 605. The second subset of the plurality of stacked laminations ensures that the oil flow is directed efficiently through the rotor body 250 to the magnet slots, enhancing the cooling efficiency and reducing spin-loss in the rotor.

In exemplary embodiments, the shaft of the rotor assembly includes a plurality of radial apertures, specifically eight apertures, evenly spaced around the circumference of the shaft. This configuration ensures that oil is uniformly distributed from the shaft to the rotor body, providing consistent cooling to the internal components. The even spacing of the radial apertures around the shaft circumference allows for a balanced and efficient flow of oil, reducing the risk of localized overheating and ensuring optimal thermal management across the entire rotor assembly.

In the rotor assembly, the plurality of stacked laminations includes a first lamination that includes four openings. These openings are positioned to align with the first four of the eight radial apertures in the shaft. This alignment facilitates the precise flow of oil from the shaft through the first lamination and into the rotor body, ensuring that the oil reaches the designated magnet slots for effective cooling. The design of the first lamination with its four openings ensures that the oil flow is directed efficiently, enhancing the overall cooling performance of the rotor assembly. Additionally, the plurality of stacked laminations includes a second lamination that also includes four openings. Each of these openings is configured to align with the second four of the eight radial apertures in the shaft. This alignment ensures that the oil flow is evenly distributed through the second lamination, further enhancing the cooling efficiency of the rotor assembly. By having both the first and second laminations with openings aligned to different sets of radial apertures, the design ensures a comprehensive and balanced distribution of oil throughout the rotor body.

In an exemplary embodiment, at least two of the first four apertures in the first lamination are immediately adjacent to one another. This adjacency allows for a concentrated flow of oil to specific areas of the rotor body, providing targeted cooling to critical components. The strategic placement of adjacent apertures ensures that high-heat regions receive adequate cooling, thereby enhancing the overall thermal management and reliability of the rotor assembly. This design feature ensures that the rotor assembly can maintain optimal operating temperatures even under demanding conditions, reducing the risk of overheating and improving the longevity of the electric machine.

In exemplary embodiments, the fourth portion of the first fluid passage has a cross-sectional shape that is configured to evenly split a fluid flowing through the fourth portion to the fifth portion and the sixth portion during the operation of the electric machine. In exemplary embodiments, uniform distribution is needed to maintain consistent cooling across the magnets housed in the first and second magnet slots, thereby preventing localized overheating and ensuring optimal thermal management of the rotor assembly. By evenly splitting the fluid flow, the design minimizes the risk of imbalanced oil distribution, which can lead to uneven cooling and potential hotspots within the rotor. This balanced flow contributes to the overall efficiency and reliability of the electric machine, as it ensures that all magnets receive adequate cooling, reducing the likelihood of thermal stress and degradation over time. As described above, the cross-sectional shape of the fourth portion of the first fluid passage may be triangular. However, as will be appreciated by those of ordinary skill in the art, the cross-sectional shape of the fourth portion of the first fluid passage may be circular or semi-circular.

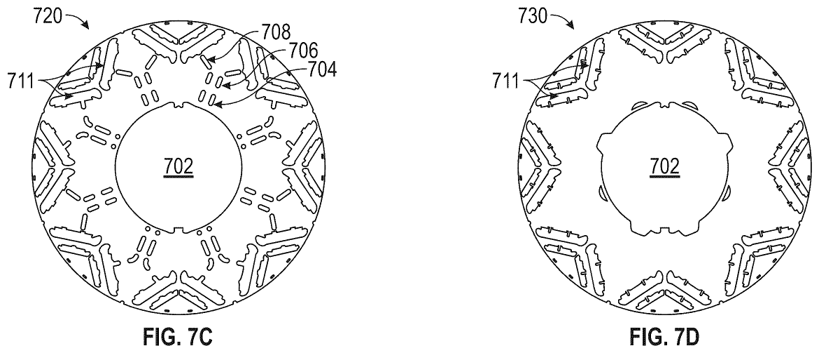

Referring now to FIGS. 7A-7D, lamination design for a subset of laminations 700, 710, 720, and 730 in a rotor body in accordance with an embodiment are shown. In exemplary embodiments, the laminations 700, 710, 720, and 730 are stacked in the following order lamination 700 is disposed adjacent to lamination 710 and lamination 720 is disposed adjacent to lamination 730. Lamination 710 is disposed between lamination 700 and lamination 720. Likewise, lamination 720 is disposed between lamination 710 and lamination 730. Each of laminations 700, 710, 720, and 730 includes magnet slots 711 and a central aperture 702. In exemplary embodiments, the magnet slots 711 are distributed circumferentially around the laminations 700, 710, 720, and 730 and are designed to house the magnets. These slots ensure that the magnets are securely positioned within the rotor body, allowing for efficient magnetic interaction with the stator windings. In exemplary embodiments, the central aperture 702 is located at the center of the laminations 700, 710, 720, and 730. This aperture is aligned with the central apertures of other laminations to define a shaft slot, which accommodates the rotor shaft.

In exemplary embodiments, lamination 700 includes first openings 701 that are positioned near the central aperture 702 and are designed to align with a radial aperture in the rotor shaft. These openings facilitate the flow of oil from the shaft to the magnet slots 711. In exemplary embodiments, the first opening 701 has a hemispherical cross section. Lamination 710 includes second openings 703, fourth openings 705, sixth openings 707, and eighth openings 709 and lamination 720 includes third openings 704, fifth opening 706, and seventh openings 708. When the laminations 700, 710, 720, and 730 are stacked, as described above, two fluid channels are formed through the openings 701-709. The fluid channels are each configured to provide oil flow to one of the magnets disposed in magnet slots 711. In exemplary embodiments, the subset of laminations 700, 710, 720, and 730 may include multiple laminations 710 and/or 720 and the number of these laminations will determine an axial length of the first fluid channel. In exemplary embodiments, the geometry of the first opening 701 is configured to evenly distribute the flow of oil from the rotor shaft into each of the second openings 703, thereby evenly distributing the flow of oil between the two fluid channels.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rotor for an electric machine comprising:
a rotor body formed from a plurality of stacked laminations defining a first axial end and an opposing second axial end, each of the plurality of stacked laminations including a plurality of magnet slots that are aligned through the rotor body and central apertures that are aligned so as to define a shaft slot; and
a shaft disposed within the shaft slot, wherein the shaft includes a plurality of radial apertures fluidly connected to an axial channel disposed within the shaft;
wherein a first subset of the plurality of stacked laminations include openings that define a first fluid passage that includes a first portion that extends from a first aperture of the plurality of radial apertures in a radial direction away from the shaft, a second portion that extends from the first portion in an axial direction towards the first axial end, a third portion that extends from the second portion in the radial direction away from the shaft, a fourth portion that extends from the third portion in the axial direction towards the second axial end, a fifth portion that extends from the fourth portion to a first magnet slot of the plurality of magnet slots, and a sixth portion that extends from the fourth portion to a second magnet slot of the plurality of magnet slots.

2. The rotor of claim 1, wherein the fourth portion of the first fluid passage has a cross-sectional shape that is triangular and has a first, second and third sides, wherein the first side is generally parallel with second portion of the first fluid passage, the fifth portion extends from the second side, and the sixth portion extends from the third side.

3. The rotor of claim 1, wherein the fourth portion of the first fluid passage has a cross-sectional shape that is configured to evenly split a fluid flowing through the fourth portion to the fifth portion and the sixth portion during operation of the electric machine.

4. The rotor of claim 1, wherein the first subset of the plurality of stacked laminations includes a first lamination that includes an opening that is configured to align with the first aperture, wherein dimensions of the opening are configured to regulate a flow of a fluid through the first fluid passage.

5. The rotor of claim 1, wherein a second subset of the plurality of stacked laminations include openings that define a second fluid passage that includes a first portion that extends from a second aperture of the plurality of radial apertures in the radial direction away from the shaft, a second portion that extends from the first portion in an axial direction towards the second axial end, a third portion that extends from the second portion in the radial direction away from the shaft, a fourth portion that extends from the third portion in the axial direction towards the first axial end, a fifth portion that extends from the fourth portion to a third magnet slot of the plurality of magnet slots, and a sixth portion that extends from the fourth portion to a fourth magnet slot of the plurality of magnet slots.

6. The rotor of claim 5, wherein the second subset of the plurality of stacked laminations is disposed adjacent to the first subset of the plurality of stacked laminations.

7. The rotor of claim 1, wherein the plurality of radial apertures includes eight apertures evenly spaced around a circumference of shaft.

8. The rotor of claim 7, wherein the plurality of stacked laminations includes a first lamination comprising four openings that are configured to align with a first four of the eight apertures.

9. The rotor of claim 8, wherein the plurality of stacked laminations includes a second lamination comprising four openings that are each configured to align with a second four of the eight apertures.

10. The rotor of claim 8, wherein at least two of the first four apertures are immediately adjacent to one another.

11. An electric machine comprising:
a stator; and
a rotor rotatably arranged within the stator, the rotor comprising:
a plurality of stacked laminations defining a first axial end and an opposing second axial end, each of the plurality of stacked laminations including a plurality of magnet slots that are aligned through a rotor body and central apertures that are aligned so as to define a shaft slot; and
a shaft disposed within the shaft slot, wherein the shaft includes a plurality of radial apertures fluidly connected to an axial channel disposed within the shaft;
wherein a first subset of the plurality of stacked laminations include openings that define a first fluid passage that includes a first portion that extends from a first aperture of the plurality of radial apertures in a radial direction away from the shaft, a second portion that extends from the first portion in an axial direction towards the first axial end, a third portion that extends from the second portion in the radial direction away from the shaft, a fourth portion that extends from the third portion in the axial direction towards the second axial end, a fifth portion that extends from the fourth portion to a first magnet slot of the plurality of magnet slots, and a sixth portion that extends from the fourth portion to a second magnet slot of the plurality of magnet slots.

12. The electric machine of claim 11, wherein the fourth portion of the first fluid passage has a cross-sectional shape that is triangular and has a first, second and third sides, wherein the first side is generally parallel with second portion of the first fluid passage, the fifth portion extends from the second side, and the sixth portion extends from the third side.

13. The electric machine of claim 11, wherein the fourth portion of the first fluid passage has a cross-sectional shape that is configured to evenly split a fluid flowing through the fourth portion to the fifth portion and the sixth portion during operation of the electric machine.

14. The electric machine of claim 11, wherein the first subset of the plurality of stacked laminations includes a first lamination that includes an opening that is configured to align with the first aperture, wherein dimensions of the opening are configured to regulate a flow of a fluid through the first fluid passage.

15. The electric machine of claim 11, wherein a second subset of the plurality of stacked laminations include openings that define a second fluid passage that includes a first portion that extends from a second aperture of the plurality of radial apertures in the radial direction away from the shaft, a second portion that extends from the first portion in an axial direction towards the second axial end, a third portion that extends from the second portion in the radial direction away from the shaft, a fourth portion that extends from the third portion in the axial direction towards the first axial end, a fifth portion that extends from the fourth portion to a third magnet slot of the plurality of magnet slots, and a sixth portion that extends from the fourth portion to a fourth magnet slot of the plurality of magnet slots.

16. The electric machine of claim 15, wherein the second subset of the plurality of stacked laminations is disposed adjacent to the first subset of the plurality of stacked laminations.

17. The electric machine of claim 11, wherein the plurality of radial apertures includes eight apertures evenly spaced around a circumference of shaft.

18. The electric machine of claim 17, wherein the plurality of stacked laminations includes a first lamination comprising four openings that are configured to align with a first four of the eight apertures.

19. The electric machine of claim 18, wherein the plurality of stacked laminations includes a second lamination comprising four openings that are each configured to align with a second four of the eight apertures.

20. The electric machine of claim 18, wherein at least two of the first four apertures are immediately adjacent to one another.
